(19) United States
(12) Patent Application Publication
(10) Pub. No.: US 2012/0258320 A1
(43) Pub. Date: Oct. 11, 2012

(54) SURFACE CONDITIONING FOR IMPROVING BONE CEMENT ADHESION TO CERAMIC SUBSTRATES

(76) Inventor: Stefan Berger, Jena (DE)

(21) Appl. No.: 13/515,591

(22) PCT Filed: Dec. 16, 2010
(86) PCT No.: PCT/EP10/70000

§ 371 Date: Jun. 13, 2012

(30) Foreign Application Priority Data
Dec. 17, 2009 (DE) 102009054871.8

(51) Int. Cl. C01B 33/00; B32B 18/00; C07F 19/00

(52) U.S. Cl. 428/447; 423/327.1; 423/326; 556/173; 556/10

(57) ABSTRACT

The invention relates to a ceramic substrate, the surface of which is modified for improving bone cement adhesion.

The present invention relates to a ceramic substrate, the surface of which is modified for improving bone cement adhesion,

The aim of surface modification of ceramic substrates which, for example, are intended to be used as implants, is to improve adhesion of commercially available bone cements based on polymethyl methacrylate (PMA) in order to obtain high bond strength between substrate material and cement. EP 1 202 702 B1 discloses a method in which cement adhesion to an implant can be improved by a three-layered coating system on the implant. Said three-layered system consists of (i) a silicate layer (SiO₂), (ii) a silane bonding agent and (iii) a preserving polymeric top coat. Applying the SiO₂ layer is mandatory here in order to ensure bonding of the silane bonding agent the preconditioned surface.

It was an object of the present invention to provide surface conditioning for improving bone cement adhesion to ceramic substrates which, for example, are intended to be used as implants, which surface conditioning is simplified with respect to the prior art.

This object is achieved according to the invention by a substrate with the features of the main claim. Preferred configurations are characterized in the sub-claims.

It was surprisingly found that ceramic substrates which have on their surface sufficient hydroxyl groups (OH groups), which include, for example, aluminum oxide ceramics, zirconium. oxide ceramics and mixed ceramics in varying compositions from zirconium oxide and aluminum oxide, can be immediately modified with appropriately selected and suitable silane bonding agents. According to the invention, the previous application of a SiO₂ layer is no longer required. Silane bonding agents which are suitable according to the invention are certain silence, preferably methoxysilanes, ethoxysilanes and/or chlorosilanes. These silanes react with the OH groups of the substrate surface, wherein a covalent bond between the silane and the substrate is formed,

Successful bonding of different bonding agents was proved by determining the contact angle of water and also by determining the silicon content on the substrate surface.

Furthermore, for improving cement adhesion it is of advantage to use a sterile silane bonding agent which, on the one hand, reacts with the OH groups of the substrate surface and, on the other, has at least one reactive group which can react with the monomeric component (methyl methacrylate) of the bone cement. Sterile silane bonding agents with reactive acrylate groups or methacrylate groups have proven to be preferred according to the invention for this.

The surface preconditioned by means of a suitable and sterile silane bonding agent can be brought in contact with commercial bone cement immediately after applying the sterile silane bonding agent, whereby due to a chemical reaction between the acrylate groups or methacrylate groups of the sterile silane bonding agent with the monomeric components of the bone cement, covalent bonds are created which ensure a firm bond between substrate and cement. Surprisingly, this bond is also formed under humid conditions, for example also in aqueous media.

Furthermore, according to the invention, it is possible to apply a polymeric top coat onto the substrate surface preconditioned with a suitable silane bonding agent, wherein after complete polymerzaton, said polymeric top coat serves as a protective function of the substrate surface. Top coats based on methyl methacrylate, polymethyl methacrylate, BisGMA (bisphenol-A glycidyl metacrviate), TEGDMA (triethylenglycoldimethacrylate), phenolic resin and/or mixtures of these components have proven to be preferred according to the invention as protective layers. Here, the reactive double bonds contained in the protective layers react with the double bonds of the silane bonding agent so that the silane bonding agent can no longer be physically or chemically contaminated.

Thereafter, the substrate preconditioned with a silane bonding agent and a polymeric protective layer can be sterilized by means of suitable methods and packaged under sterile conditions, Such sterilized and packaged substrates are protected against contamination and can be stored or transported for several months without any loss of quality. By applying bone cement onto the substrate surface preconditioned with a silane bonding agent and the polymeric top coat, the polymeric top coat is activated and as a result, the polymeric top coat is alloyed into the polymer network of the bone cement. Thereby, highly adhesive bonds between bone cement and substrate material are created, which are also stable in an aqueous medium.

Thus, the present invention relates to a ceramic substrate in which
the surface of the substrate is modified with a silane bonding agent.

Particularly preferred is a ceramic substrate according to the invention, wherein
the substrate has hydroxyl groups (OH groups) on its surface;
the substrate aluminum oxide ceramic, a zirconium. oxide ceramic or a mixed ceramic in varying compositions from zirconium oxide and aluminum oxide;

the silane bonding agent is a silane which forms a covalent bond with the OH groups of the substrate surface;
the silane bonding agent is selected from among sterile silane bonding agents;
the silane bonding agent is selected from among the methoxyailanes, ethozysilanes and/or chlorosilanes;
the sterile silane bonding agent, on the one hand, reacts with the OH groups of the substrate surface and, on the other, has at least one reactive group which can react with the monomeric component of bone cement;
the sterile silane comprises reactive acrylate groups or methacrylate groups,

Furthermore, the present invention relates to a ceramic substrate, wherein
the substrate surface preconditioned with a silane bonding agent additionally comprises a polymeric top coat which, after complete polymerization, serves as protective function of the substrate surface.

Particularly preferred is a ceramic substrate according to the invention with a polymer dc top coat, wherein
the top coat is based on methyl methacrylate, polymethyl methacrylate, BisGMA, TEGDMA, phenolic resin and/or mixtures of these components.

1-10. (canceled)

11. A ceramic substrate, wherein a surface of the substrate is modified with a silane bonding agent.

12. The ceramic substrate according to claim 11, wherein the substrate has hydroxyl groups on its surface.

13. The ceramic substrate according to claim 11, wherein the substrate comprises at least one ceramic selected from the group consisting of an aluminum ceramic and a zirconium ceramic.

14. The ceramic substrate according to claim 12, wherein the silane bonding agent is a silane which forms a covalent bond with the OH groups of the substrate surface.

15. The ceramic substrate according to claim 11, wherein the silane bonding agent is selected from among sterile silane bonding agents.

16. The ceramic substrate according to claim 11, wherein the silane bonding agent comprises at least one member selected from the group consisting of a methoxysilane, an ethoxysilane and a chlorosilane.

17. The ceramic substrate according to claim 12, wherein the sterile silane bonding agent reacts with the OH groups of the substrate surface and has at least one reactive group which can react with the monomeric component of bone cement.

18. The ceramic substrate according to claim 11, wherein the sterile silane bonding agent comprises reactive acrylate groups or methacrylate groups.

19. The ceramic substrate according to claim 11, wherein the substrate surface preconditioned with the silane bonding agent further comprises a polymeric top coat which, after complete polymerization, serves as a protective function of the substrate surface.

20. The ceramic substrate according to claim 19, wherein the top coat is based on methyl methacrylate, polymethyl methacrylate, BisGMA, TEGDMA, phenolic resin or a mixture thereof.
